(19) United States
(12) Patent Application Publication
(10) Pub. No.: US 2010/0154185 A1
(43) Pub. Date: Jun. 24, 2010

(54) TOOL KIT AND METHOD FOR REMOVING BROKEN SPARK PLUG COMPONENTS FROM AN INTERNAL COMBUSTION ENGINE

(76) Inventors: John Schallert, Raynham, MA (US); William F. Fraccastoro, Raynham, MA (US)

Correspondence Address: Russ Weinzimmer, 614 Nashua Street, Suite 53, Milford, NH, 03055, US

(21) Appl. No.: 12/342,982

(22) Filed: Dec. 23, 2008

(51) Int. Cl. B25B 27/18

(52) U.S. Cl. 29/270; 29/764; 29/426.5

(57) ABSTRACT

An inexpensive, easy to use, convenient, and effective tool kit and method of use are disclosed for removing broken spark plug components from a cylinder head. The tool kit includes a rigid wire that can be wedged into the central hole of a broken insulator component, allowing withdrawal of the insulator, and a tapered drill that can bite into a broken sheath component, engage the sheath, and break it free for removal. The rigid wire can be angled and/or the tapered drill can include a universal joint, so as to reach inaccessible areas. The method includes inserting the rigid wire into a spark plug hole, wedging it into the insulator central hole, and removing the insulator. Then the tapered drill is inserted into the spark plug hole and pressed and rotated into the hollow sheath to engage it and break it free. Finally, the sheath is removed with the drill.

### FIELD OF THE INVENTION

This invention generally relates to tools, and more specifically to automotive repair tools.

### BACKGROUND OF THE INVENTION

Periodic replacement of spark plugs is important to the routine maintenance of an internal combustion engine. The frequency of spark plug replacement depends on the design of the engine and on the type of spark plugs used. Standard spark plugs are typically replaced every 20,000 to 30,000 miles, while platinum and iridium spark plugs are typically replaced every 60,000 to 80,000 miles.

Unfortunately, due to prolonged exposure to heat and the consequent expansion and contraction, as well as corrosion and carbon build up on engine and spark plug surfaces, a spark plug can sometimes become stuck to a cylinder head. This can cause the spark plug to fracture, either while in use or during attempted removal of the spark plug. As a result, a broken portion of the spark plug can remain lodged in the cylinder head when the remainder is removed. In particular, some spark plugs can fracture and become separated into multiple components, such that a lower sheath and insulator remain lodged in the cylinder head while the central conductor and upper portion of the spark plug are removed. This is common, for example, for spark plugs used in the engine of a Ford model F-150, as well as engines in many other models, representing approximately 5 million vehicles.

The method of last resort for removing a broken spark plug from an engine is to remove the cylinder head so as to gain access to the spark plug components that remain lodged therein. However, this approach is very costly and time consuming. There are several devices available for attempting to remove a broken spark plug without removal of the cylinder head. Some are grippers or wrenches that attempt to pull a spark plug out of a cylinder by grabbing and pulling on the spark plug. However, such devices are only effective when the portion of the spark plug that remains lodged in the cylinder head includes a protruding section that can be grasped by a gripper tool. Hence, these tools are not effective when only the sheath and insulator remain in the engine.

Another approach is to use a drill or grinding tool to pulverize the ceramic insulator. A tap is then used to cut threads into the metal sheath, and a threaded rod is used to pull the sheath out of the cylinder head. This approach is costly and time consuming, since it requires the use of at least three specialized tools. In addition, this approach can generate a significant amount of debris, including pulverized ceramic and metal cuttings from tapping the sheath, and there is a risk that too much of this debris may fall into the engine cylinder. Furthermore, access to the engine spark plug holes is often limited in many automobile models, such that it can be necessary to remove the hood of the automobile so as to use these spark plug removal tools.

### SUMMARY OF THE INVENTION

An inexpensive, easy to use, convenient, and effective spark plug removal tool kit and method of use thereof are claimed for removing broken and/or damaged spark plug components from an engine cylinder head. The tool kit comprises a rigid wire for removing an insulator component of a broken spark plug, and a tapered drill for removing a sheath component of a broken spark plug. The method comprises inserting one end of the rigid wire into the spark plug hole of an automobile engine, engaging the central hole of the insulator component, and removing the insulator component. The method further entails inserting the tapered drill into the spark plug hole, rotating it so as to cut into the sheath component, thereby simultaneously engaging the sheath and breaking the sheath loose from the cylinder head, and then removing the sheath component. In preferred embodiments, the tapered drill includes a multidirectional joint that allows application of the tapered drill to spark plug holes with limited accessibility, such as spark plug holes with limited clearance beneath the hood.

One general aspect of the present invention is a spark plug removal tool kit for removing components of a broken spark plug from a spark plug hole in an automobile engine cylinder head. The tool kit includes a rigid wire for engaging the central hole of an insulator component of the spark plug and removing the insulator component, and a tapered drill for engaging and removing a sheath component of the spark plug. In preferred embodiments, the diameter of a distal end of the rigid wire allows it to fit tightly into the hollow center of the insulator component. In some of these embodiments, the distal end of the rigid wire tapers to form a rounded conical shape. In other preferred embodiments, a distal portion of the rigid wire has a textured surface, so as to enhance its ability to engage the insulator component. In some of these embodiments the textured surface includes longitudinal grooves, rings, and/or barbs.

In further preferred embodiments, a proximal end of the rigid wire is bent at an angle for enhanced manipulability or includes a right angle portion forming a T configuration for enhanced manipulability. In still other preferred embodiments, a distal end of the tapered drill is able to fit tightly into the hollow of the sheath component. In further preferred embodiments, a proximal end of the tapered drill is attached to a multi-directional or universal joint for enhanced manipulability.

Another general aspect of the present invention is a method for removing components of a broken spark plug from a spark plug hole in an automobile engine cylinder head. The method includes the following steps:

inserting a distal end of a rigid wire into the spark plug hole, the distal end of the rigid wire being engagable with a central hole in an insulator component of the broken spark plug;

engaging the distal end of the rigid wire with the central hole of the insulator component;

withdrawing the rigid wire from the spark plug hole, thereby removing the insulator component;

inserting a tapered drill into the spark plug hole, a distal end of the tapered drill having a shape that allows it to be partially inserted into a sheath component of the broken spark plug so as to cut into the sheath component;

rotating the tapered drill while its distal end is partially inserted into the sheath component of the broken spark plug, thereby causing the distal end of the tapered drill to cut into the sheath component, engage with the sheath component, and free the sheath component from the cylinder head if necessary; and

removing the drill from the spark plug hole, thereby removing the sheath component from the cylinder head.

In preferred embodiments, the distal end of the rigid wire is able to be fit tightly into the central hole of the insulator component. In some of these embodiments, the distal tip of the rigid wire tapers to form rounded conical shape. In other preferred embodiments, a distal portion of the rigid wire has a textured surface, so as to enhance its ability to engage the insulator component. In some of these embodiments, the textured surface includes longitudinal grooves, rings, and/or barbs. In further preferred embodiments, the rigid wire is bent at a right angle for enhanced manipulability or includes a right angle portion forming a T configuration for enhanced manipulability. In still other preferred embodiments, the tapered drill is able to fit tightly into the hollow of the insulator component. In further preferred embodiments, the tapered drill is attached to a multi-directional joint or to a universal joint for enhanced manipulability.

### BRIEF DESCRIPTION OF THE DRAWINGS

The invention will be more fully understood by reference to the detailed description, in conjunction with the following figures, wherein:

FIG. 1A is a side view of an intact spark plug to which the present invention is applicable;

FIG. 1B is an exploded side view of the spark plug of FIG. 1A, showing the separate insulator and sheath components.

FIG. 2A is a side view of the distal portion of a rigid wire from an embodiment in which the rigid wire includes a tapered tip;

FIG. 2B is a side view of the distal portion of a tapered drill from a preferred embodiment;

FIG. 3A is an oblique side view of a rigid wire from a preferred embodiment in which the proximal end of the rigid wire is bent at an angle;

FIG. 3B is an oblique side view of a rigid wire from a preferred embodiment in which the proximal end of the rigid wire includes a T-handle;

FIG. 4A is an oblique side view of the distal end of a rigid wire from a preferred embodiment in which a distal portion of the rigid wire has a textured surface that includes longitudinal grooves;

FIG. 4B is an oblique side view of the distal end of a rigid wire from a preferred embodiment in which a distal portion of the rigid wire has a textured surface that includes barbs oriented away from the distal tip;

FIG. 4C is an oblique side view of the distal end of a rigid wire from a preferred embodiment in which a distal portion of the rigid wire has a textured surface that includes circumferential rings;

FIG. 5A is a side view of a tapered drill from a preferred embodiment in which the proximal end of the tapered drill is attached to a multi-directional ball and socket joint;

FIG. 5B is a side view of a tapered drill from a preferred embodiment in which the proximal end of the tapered drill is attached to a universal joint;

FIG. 6A illustrates the distal end of the rigid wire approaching the central hole of the insulator component.

FIG. 6B illustrates the distal end of the rigid wire engaged with the central hole of the insulator component in preparation for removing the ceramic insulator from the cylinder head;

FIG. 7A illustrates the distal end of the tapered drill approaching the sheath component;

FIG. 7B illustrates the distal end of the tapered drill in contact with the sheath component and being rotated so as to cut into the sheath component, engage with the sheath component, and break the sheath component free from the surrounding cylinder head;

FIG. 7C illustrates the distal end of the tapered drill engaged with the sheath component in preparation for removing the sheath component from the cylinder head; and

FIG. 8 is a flow diagram detailing the method of use of the invention.

### DETAILED DESCRIPTION OF PREFERRED EMBODIMENTS

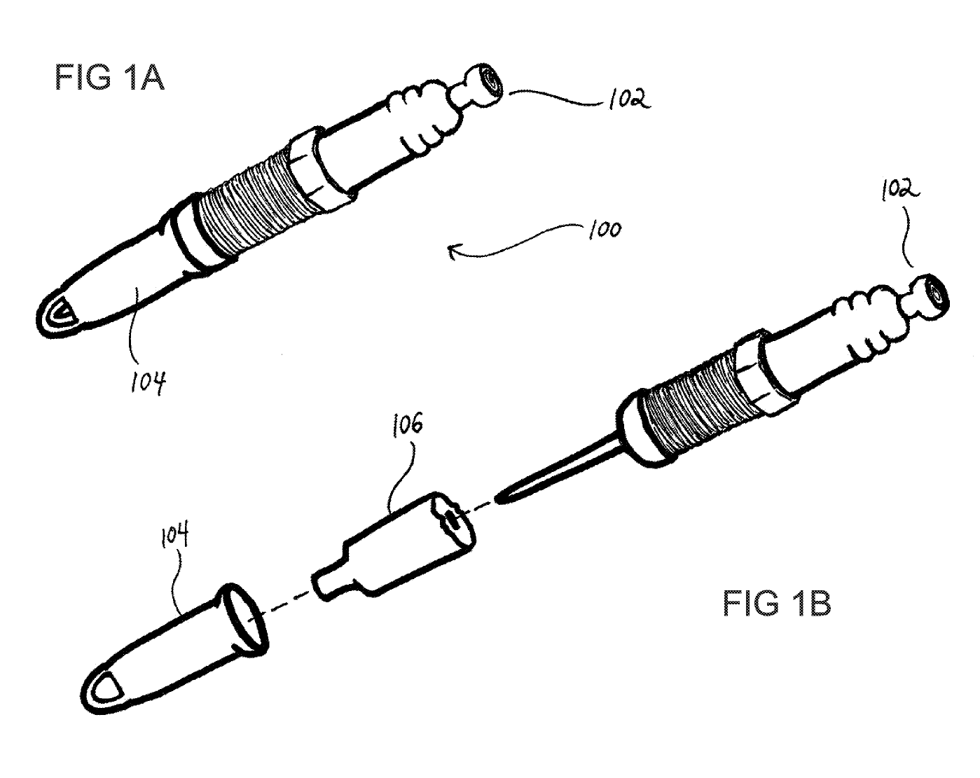

FIG. 1A is a side view of an intact spark plug 100 of a type to which the present invention is applicable. A terminal electrode 102 is located at one end of the spark plug. An insulator component surrounds a central conductor, and a metal sheath 104 encases the insulator component. The metal sheath 104 is located at the end of the spark plug that is opposite from the terminal electrode.

FIG. 1B is an exploded side view of the spark plug of FIG. 1A, showing the components of a broken spark plug as they might become separated during spark plug removal. Due to engine heating and the associated expansion and contraction of materials, as well as corrosion and carbon buildup, spark plugs of this common type are susceptible to breaking in the manner shown. The insulator component as shown in the figure 106 is actually a broken fragment of the full insulator component. In such cases, the sheath 104 can become lodged in the cylinder head, and remain behind with a portion of the insulator component 106 when the upper portion of the spark plug is removed.

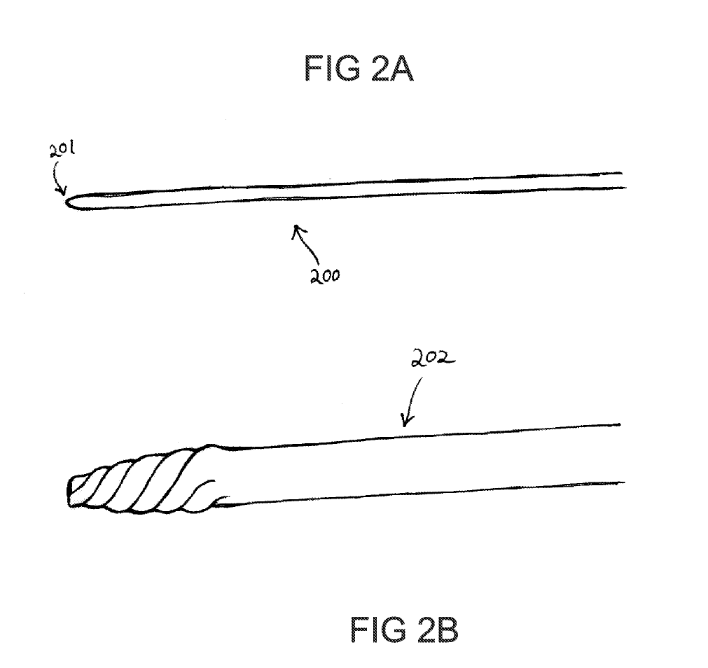

With reference to FIG. 2A and FIG. 2B, the present invention includes a rigid wire 200 and a tapered drill 202. FIG. 2A is a side view of the distal portion of a rigid wire 200 with a tapered tip 201. The rigid wire 200 can be made of any solid material such as steel or brass that provides rigidity, durability, and structural integrity, but which also allows for some degree of compressibility, so as to be able to fit tightly into the hollow center of the insulator component 106 and become wedged therein. FIG. 2B is a side view of the distal portion of a tapered drill 202. The tapered drill 202 can be made of any suitable tool material known in the art such as carbon steel, and tapered so as to be able to fit tightly into the hollow of the sheath component 104.

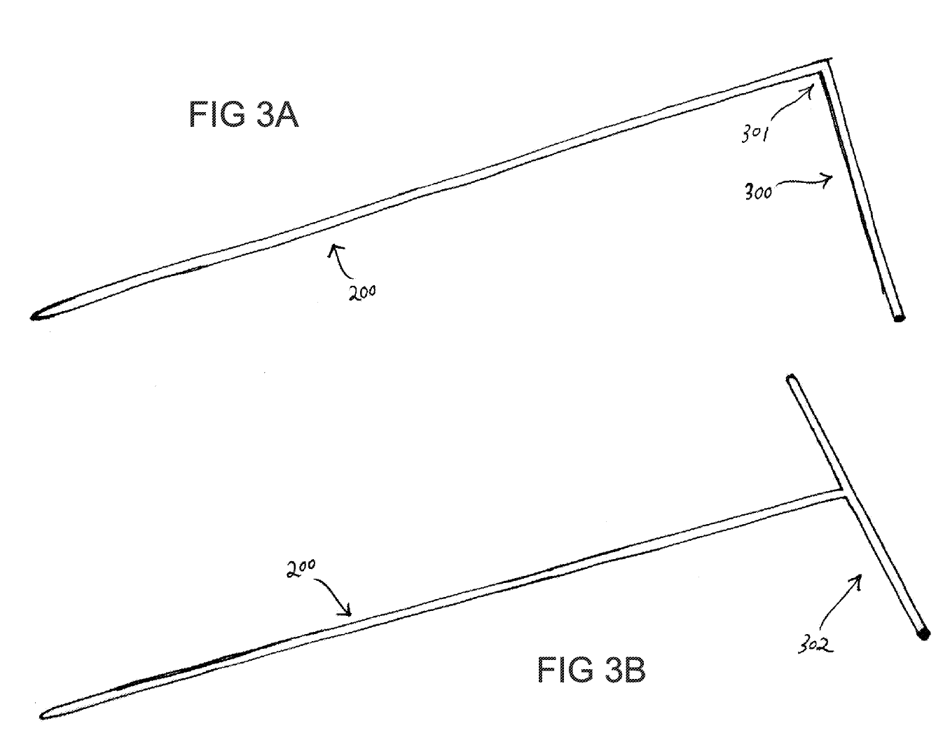

FIG. 3A is an oblique side view of a preferred embodiment of the rigid wire, wherein the wire is bent at an angle near its proximal end. In FIG. 3A, the wire 200 includes a proximal portion 300, formed by a bend 301 in the wire. In this figure, the wire includes a right angle bend 301, so as to enable a user to insert the distal end of the wire 200 into the spark plug hole of the engine with minimal effort. The proximal portion of the wire 300 can serve as a handle, and the bend 301 in the wire can enhance a user's ability to manipulate the wire 200 to engage and extract the insulator component 106 of a broken spark plug. FIG. 3B is an oblique side view of a preferred embodiment of a rigid wire that includes a T-bar handle at its proximal end. In FIG. 3B, the wire 200 includes a proximal handle 302, orthogonal to the longitudinal portion of the wire and forming a T where the two portions meet.

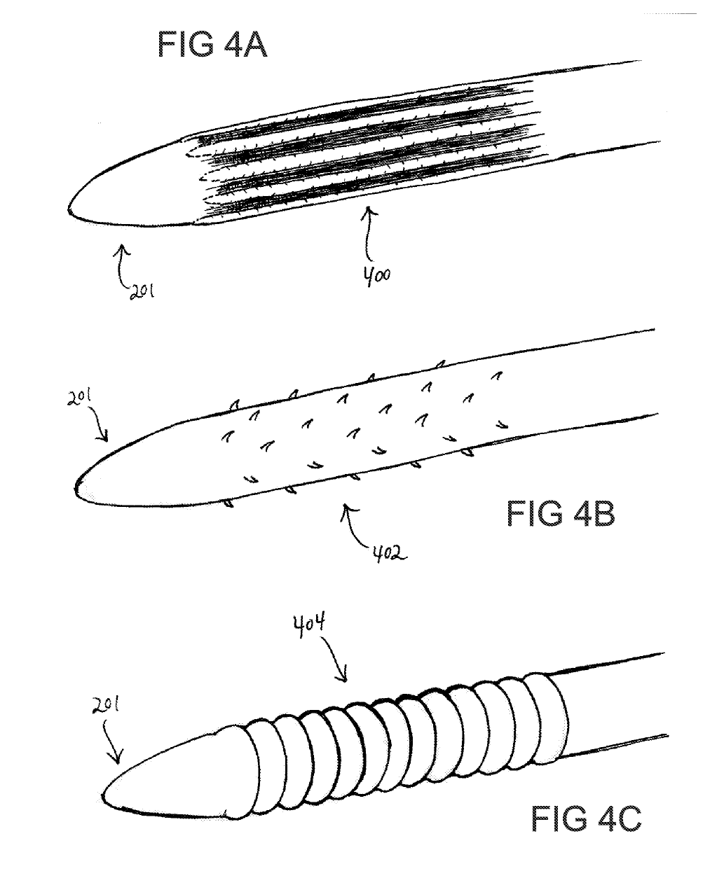

FIG. 4A, FIG. 4B, and FIG. 4C illustrate various possible textured surfaces included on a distal portion of the rigid wire so as to enhance the ability of the rigid wire to engage with the insulator component upon insertion of the wire into the insulator component. FIG. 4A is an oblique side view of the distal portion of a preferred embodiment of a rigid wire 200 with a textured surface that includes longitudinal grooves 400. FIG. 4B is an oblique side view of the distal portion of preferred embodiment of a rigid wire with a textured surface that includes barbs 402 oriented away from the distal tip. The wire also includes a tapered tip 201, so as to facilitate insertion of the wire 200 into the insulator component. FIG. 4C is an oblique side view of the distal portion of preferred embodiment of a rigid wire with a textured surface that includes circumferential rings 404. The wires shown in FIG. 4A, FIG. 4B, and FIG. 4C also include tapered tips 201 that form conical shapes so as to facilitate insertion of the wires 200 into the insulator components 106.

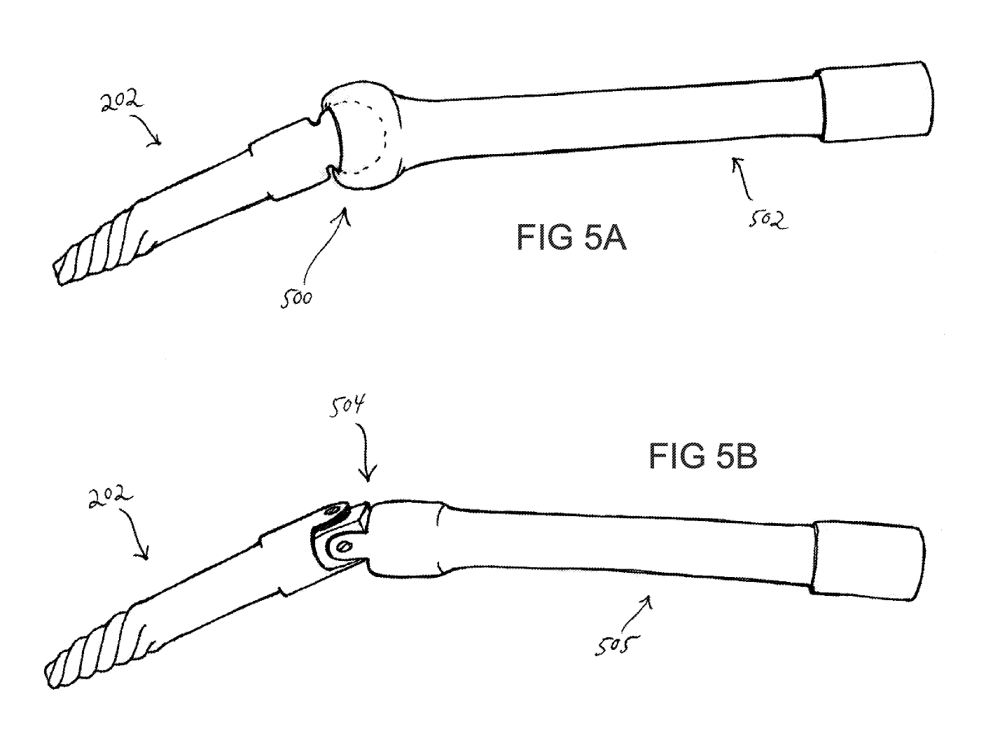

In FIG. 5A and FIG. 5B the tapered drill is shown including a joint 500, 504, for enhance manipulability. In FIG. 5A, the tapered drill includes a multi-directional ball and socket joint 500, so as to provide optimal maneuverability of the tapered drill when attempting access to spark plug holes for the engagement and extraction of the sheath component of a broken spark plug. A shaft 502 extends from the proximal portion of the ball and socket joint 500. In the embodiment of FIG. 5A, the shaft 502 terminates in a ⅜ inch box opening compatible with a standard socket wrench. In FIG. 5B, the tapered drill includes a universal joint 206 that provides even greater freedom of movement of the drill 202, and thus further enhances its manipulability. The universal joint can enable a user to insert the tapered drill 202 into a spark plug hole to which only limited access is available, for example if the spark plug hole is located near the firewall and just under the hood. A shaft 505 extends from the proximal portion of the universal joint 206. In the embodiment of FIG. 5A, the shaft 505 terminates in a ⅜ inch box opening compatible with a standard socket wrench.

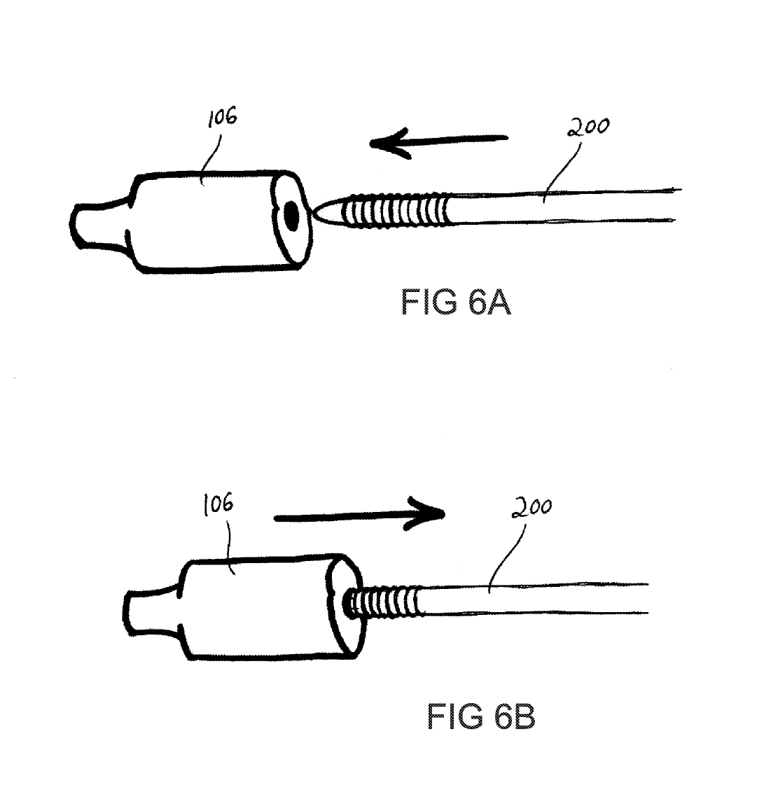

FIG. 6A and FIG. 6B illustrate use of the rigid wire 200 to remove the insulator component 106 of a broken spark plug from a spark plug hole. FIG. 6A is a diagram showing the approach of the rigid wire 200 towards the central hole of the insulator component 106. In preferred embodiments, the rigid wire 200 is configured so as to be of slightly greater diameter than the central hole of the insulator component 106. This allows the rigid wire 200 to be inserted into the insulator component 106 so as to fit tightly and wedge itself within the central hole of the insulator component 106. In the embodiment of FIG. 6A, the rigid wire 200 includes a textured portion near the tip. In FIG. 6A, the textured portion includes circumferential rings. FIG. 6B illustrates the engagement and removal of the insulator component 106 using the rigid wire 200. Once the rigid wire 200 has been wedged into the central hole of the insulator component 106, the rigid wire 200 can be used to pull the insulator component 106 out of the sheath 104 and out of the spark plug hole.

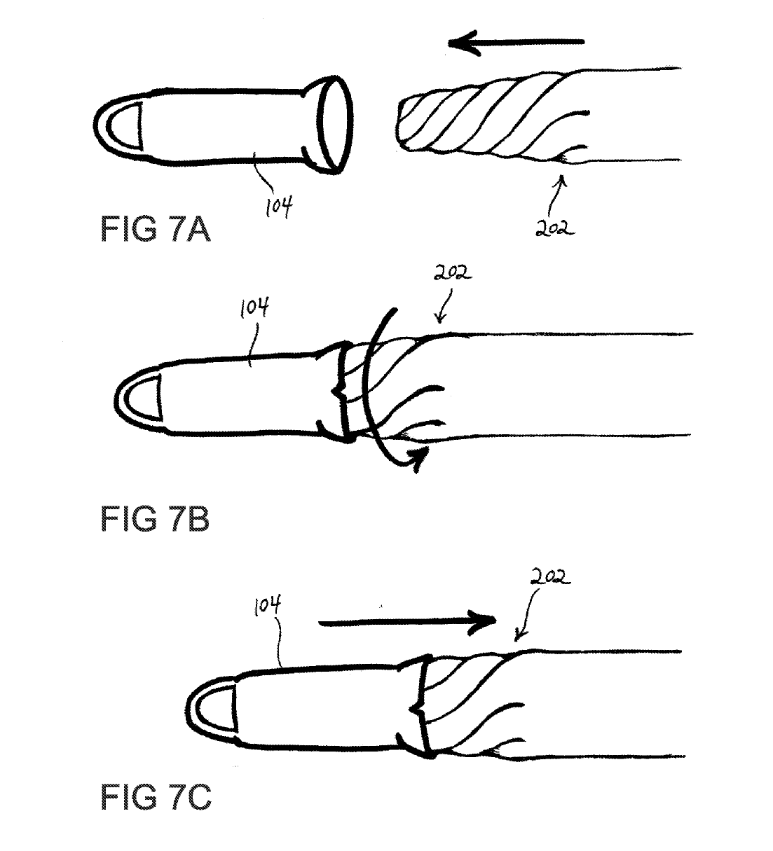

FIG. 7A, FIG. 7B and FIG. 7C illustrate use of the tapered drill to remove the sheath component 104 of a broken spark plug from a spark plug hole. FIG. 7A illustrates the approach of the tapered drill 202 towards the sheath component 104. In preferred embodiments, the tapered drill 202 is shaped such that it can be partially inserted into the hollow of the sheath component 104 of the broken spark plug.

FIG. 7B illustrates engagement of the sheath component 104 with the tapered drill 202. The tapered drill 202 is inserted into the hollow of the sheath component 104 and rotated, causing it to cut into the sheath component 104 and firmly engage with the sheath component 104. This rotary motion also serves to break the sheath component 104 free from the surrounding cylinder head. Finally, as illustrated in FIG. 7C, the sheath component 104 is removed together with the tapered drill 202.

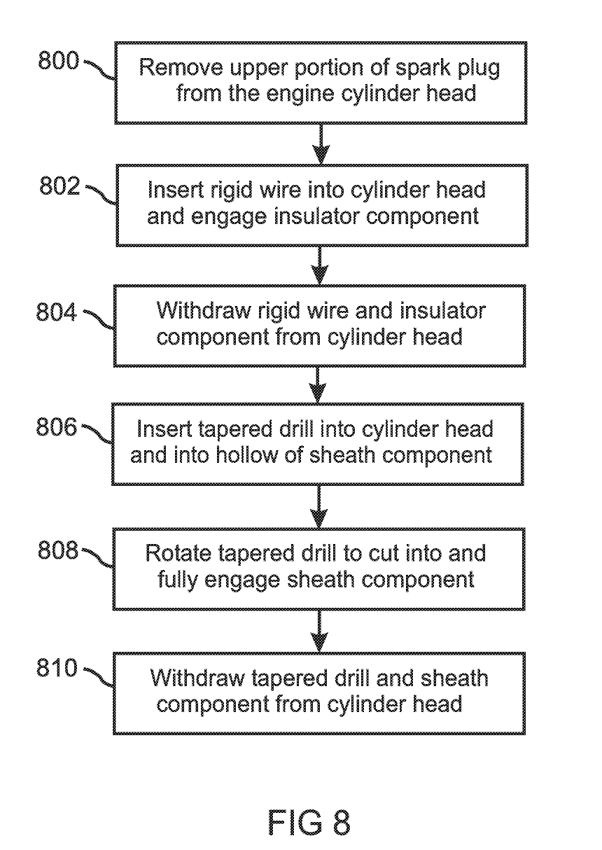

FIG. 8 is a flow diagram detailing the steps of the method of use of the invention. First, the upper portion of the broken spark plug is removed from the spark plug hole in the engine's cylinder head, 800. Typically, if the lower portion of the spark plug has become fixed to the cylinder head, attempting to remove the spark plug in a conventional fashion will cause the spark plug to break and only the upper half to be removed. If the spark plug has fractured during use, the result will be the same even if the portion left behind has not become fixed to the cylinder head. Next, the rigid wire 200 of the present invention is inserted into the spark plug hole, and is pressed firmly into the central hole of the broken insulator component 106, so as to engage the insulator component, 802. Then, the rigid wire 200 is withdrawn from the cylinder head, bringing the broken insulator component 106 with it 804.

To remove the sheath component 104 of the broken spark plug, initially the tapered drill 802 is inserted into the cylinder head and is pressed firmly into the hollow of the sheath component, 506. Next, the tapered drill 802 is rotated, so as to cut into the sheath component 106 and engage with it 808. If the sheath component has become fixed to the cylinder head, the tapered drill 202 will bite into the sheath component 104, and impart a torque to the sheath component 104, causing the sheath component 104 to twist free from the cylinder head. Finally, the tapered drill 202 is withdrawn from the cylinder head, bringing the sheath component 104 with it 810.

Those skilled in the art will readily understand that some additional measures, such as vacuuming and/or lubricating the area inside the spark plug hole, may be advisable before, during, and/or after some of the steps of removal of the broken spark plug components that are outlined above.

Other modifications and implementations will occur to those skilled in the art without departing from the spirit and the scope of the invention as claimed. Accordingly, the above description is not intended to limit the invention except as indicated in the following claims.

What is claimed is:

1. A spark plug removal tool kit for removing components of a broken spark plug from a spark plug hole in an automobile engine cylinder head, the tool kit comprising:
a rigid wire for engaging the central hole of an insulator component of the spark plug and removing the insulator component; and
a tapered drill for engaging and removing a sheath component of the spark plug.

2. The tool kit of claim 1, wherein the diameter of a distal end of the rigid wire allows it to fit tightly into the hollow center of the insulator component.

3. The tool kit of claim 1, wherein a distal end of the rigid wire is tapered to form a rounded, conical shape.

4. The tool kit of claim 1, wherein a distal portion of the rigid wire has a textured surface, so as to enhance its ability to engage the insulator component.

5. The tool kit of claim 4, wherein the textured surface includes one of:
longitudinal grooves;
rings; and
barbs.

6. The tool kit of claim 1, wherein a proximal end of the rigid wire is bent at an angle for enhanced manipulability.

7. The tool kit of claim 1, wherein a proximal end of the rigid wire includes a right angle portion forming a T configuration for enhanced manipulability.

8. The tool kit of claim 1, wherein a distal end of the tapered drill is able to fit tightly into the hollow of the sheath component.

9. The tool kit of claim 1, wherein a proximal end of the tapered drill is attached to a multi-directional joint for enhanced manipulability.

10. The tool kit of claim 1, wherein a proximal end of the tapered drill is attached to a universal joint for enhanced manipulability.

11. A method for removing components of a broken spark plug from a spark plug hole in an automobile engine cylinder head, the method comprising:
inserting a distal end of a rigid wire into the spark plug hole, the distal end of the rigid wire being engagable with a central hole in an insulator component of the broken spark plug;
engaging the distal end of the rigid wire with the central hole of the insulator component;
withdrawing the rigid wire from the spark plug hole, thereby removing the insulator component;
inserting a tapered drill into the spark plug hole, a distal end of the tapered drill having a shape that allows it to be partially inserted into a sheath component of the broken spark plug;
rotating the tapered drill while its distal end is partially inserted into the sheath component of the broken spark plug, thereby causing the distal end of the tapered drill to cut into the sheath component, engage with the sheath component, and free the sheath component from the cylinder head if necessary; and
removing the tapered drill from the spark plug hole, thereby removing the sheath component from the cylinder head.

12. The method of claim 11, wherein the distal end of the rigid wire is able to be fit tightly into the central hole of the insulator component.

13. The method of claim 11, wherein the distal end of the rigid wire is tapered to form a rounded, conical shape.

14. The method of claim 11, wherein a distal portion of the rigid wire has a textured surface, so as to enhance its ability to engage the insulator component.

15. The method of claim 14, wherein the textured surface includes one of:
longitudinal grooves;
rings; and
barbs.

16. The method of claim 11, wherein a proximal end of the rigid wire is bent at an angle for enhanced manipulability.

17. The method of claim 11, wherein a proximal end of the rigid wire includes a right angle portion forming a T configuration for enhanced manipulability.

18. The method of claim 11, wherein a distal end of the tapered drill is able to fit tightly into the hollow of the insulator component.

19. The method of claim 11, wherein a distal end of the tapered drill is attached to a multi-directional joint for enhanced manipulability.

20. The method of claim 11, wherein a distal end of the tapered drill is attached to a universal joint for enhanced manipulability.
